(19) United States
(12) Patent Application Publication
(10) Pub. No.: US 2016/0002538 A1
(43) Pub. Date: Jan. 7, 2016

(54) Flame Retardant Composite Particles

(71) Applicant: ShayoNano Singapore Pte Ltd., Singapore (SG)

(72) Inventors: Viswanathan Swaminathan, Singapore (SG); Varadalambedru Srinivasan Nithianandam, Singapore (SG); Mahesh Dahyabhai Patel, Singapore (SG)

(73) Assignee: ShayoNano Singapore Pte Ltd., Singapore (SG)

(21) Appl. No.: 14/770,816

(22) PCT Filed: Feb. 24, 2014
(86) PCT No.: PCT/SG2014/000078

§ 371 Date: Aug. 26, 2015

(30) Foreign Application Priority Data
Feb. 26, 2013 (GB) 1303411.1

(51) Int. Cl. C09K 21/02; C01B 13/36; C01F 5/16; C01B 13/14; C01B 13/18

(52) U.S. Cl. CPC C09K 21/02; C01B 13/145; C01B 13/18; C01F 5/16; C01B 13/36; C01P 2002/72; C01P 2004/03; C01P 2004/61; C01P 2004/62; C01P 2004/64; C01P 2004/80

(57) ABSTRACT

The present invention relates to a method of producing a composite particle having a metal oxide core and a metal hydroxide outer shell, said method comprising the steps of: (a) thermally treating a metal hydroxide under conditions to produce a pure phase crystalline metal oxide; (b) hydrating said pure phase crystalline metal oxide to form said composite particle. (c) hydrating said pure phase crystalline metal oxide under conditions to form a metal oxide inner core and a metal hydroxide outer shell.

### TECHNICAL FIELD

The present invention relates to composite particles, methods for preparing the same, and their uses thereof as flame retardants.

### BACKGROUND

Flame and fire retardant coatings have been widely employed to protect substrates against fire. In general, suitable coatings which do not change the intrinsic characteristics of the material (e.g. mechanical properties), are easily processed, and which are compatible between multiple substrate materials have been of interest in recent years.

Halogenated compounds are considered to be the most efficient gas phase flame retardants, working by suppressing ignition and slowing the spread of flames. However, such compounds can potentially lead to environmental degradation, and may pose environmental risks.

Accordingly, with rapid progress in nanotechnology, there have been significant advances in the field of developing flame and fire retardant coatings, such as polymeric composites with nanosized fillers (e.g. inorganic layered compounds, nanofibres or nanoparticles) have been studied for their suitability to act as such coatings.

One of the main difficulties encountered in developing polymeric composites is that of the poor dispersibility (for instance, due to differences in densities) of the filler compounds. In addition, in polycomposites containing inorganic layered compounds, the compatibility between the selected polymer and the layered material (commonly a clay based entity like montmorillonite) presents a challenge—the layered material may require additional intercalating agents like alkyl quaternary ammonium compounds to prevent the undesired delamination of silica layers from occurring and resulting in a poorly mixed composite-matrix.

Aside from polycomposites and halogenated compounds, additives of metal hydroxides (e.g. aluminum hydroxide) are commonly available as fire or flame retardants due to their ability to endothermically decompose upon heating. However, a high loading (e.g. >50% by weight) of these additives is usually required for minimum-protection purposes, and may not be suitably adopted in critical and larger areas which are required to be flame or fire retardant. Red phosphorous and fumed silica have been developed into composites together with metal hydroxides in attempting to reduce the required loading requirements of the hydroxides alone. However, the handling of both these materials requires extra caution in an industrial setting as they are potential health hazards.

Other materials like layered metal phosphates and carbon additives (e.g. graphite oxide and carbon nanotubes) have also been studied and put forward as potential fire/flame retardants. However, the thermal properties of these relatively new materials are not well understood, and would have to be further investigated and established before viable fire or flame retarding materials encompassing these components are commercially viable.

Accordingly, there is a need to provide alternative composite materials for use as flame retardants which overcome or at least ameliorate the disadvantages described above.

### SUMMARY

In a first aspect, there is provided a method of producing a porous composite particle comprising the step of irradiating a metal hydroxide particle under conditions to increase the porosity of the metal hydroxide particle.

In a second aspect, there is provided a method of producing a composite particle comprising the steps of:
(a) irradiating a metal hydroxide particle under conditions to increase the porosity of the metal hydroxide particle;
(b) thermally treating said porous metal hydroxide particle under conditions to yield a pure phase crystalline metal oxide;
(c) hydrating said pure phase crystalline metal oxide under conditions to form a metal oxide inner core and a metal hydroxide outer shell.

In one embodiment, the process of irradiation in (a) is carried out using microwave irradiation.

Advantageously, the disclosed method is capable of providing composite core-shell structures exhibiting superior physicochemical properties, e.g., flexural strength and improved fire retardancy.

Further advantageously, the thermal treatment step (b) is performed under conditions to yield a substantially pure phase crystalline metal oxide, which leads to the formation of the superior core-shell metal oxide/metal hydroxide composite after said hydration step (c).

Advantageously, the method of developing the composite particle is straightforward, requiring only thermal treatment of the as formed metal hydroxide powder followed by hydration of the thermally formed product.

In a third aspect, there is provided a composite particle comprising a metal oxide core encapsulated by a metal hydroxide outer shell.

Advantageously, the core-shell structure combines the technical features (e.g. high heat capacities of metal oxides, and the endothermic properties of metal hydroxides when they participate in chemical reactions) of both a metal oxide and a metal hydroxide in a single particle, and reduces the need to physically mix individual compounds of metal oxides and hydroxides when such technical features are simultaneously required in an application.

Advantageously, the plurality of composite particles also forms a phase-separation free and heterogeneous mix ready to be used in further applications.

Further advantageously, the core-shell structure provides a means of preventing the undesired aggregation of nanosized metal oxide particles via the inter-shielding of these particles with the metal hydroxide containing shell structure.

In a fourth aspect, there is provided the use of the composite particle defined above as a fire-retardant additive.

Advantageously, the composite particles when used as a fire-retardant additive undergo a net endothermic process when exposed to an elevated temperature. The subsequent decomposition of the particles release moisture that can aid in decreasing the temperatures of an ignited environment.

Further advantageously, the composite particles when used as a fire-retardant additive provide a halogen-free material that is environmentally friendly.

### DEFINITIONS

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### Disclosure of Optional Embodiments

Exemplary, non-limiting embodiments of the methods according to the first and second aspects will now be disclosed.

In one embodiment, there is provided a method of producing a porous composite particle comprising the step of irradiating a metal hydroxide particle under conditions to increase the porosity of the metal hydroxide particle. The microwaves may be of frequencies between 300 MHz to 300 GHz, selected from 300 MHz, 500 MHz, 1 GHz, 100 GHz and 300 GHz. In another embodiment, the working frequency of the microwave radiation is selected from between 300 MHz to 300 GHz.

In another embodiment, the present disclosure provides a method of producing a composite particle having a metal oxide core and a metal hydroxide outer shell, said method comprising the steps of: (a) irradiating a metal hydroxide particle under conditions to increase the porosity of the metal hydroxide particle; (b) thermally treating said porous metal hydroxide particle under conditions to yield a substantially pure phase crystalline metal oxide; (c) hydrating said pure phase crystalline metal oxide under conditions to form a metal oxide inner core and a metal hydroxide outer shell.

In a further embodiment, the said thermal treatment step comprises thermal annealing. In yet a further embodiment, the thermal annealing comprises subjecting said metal hydroxide particle to a temperature selected from 200° C. to 800° C.

In an embodiment, the thermal treatment step may comprise annealing the metal hydroxide particles at temperatures selected from about 200° C., 225° C., 250° C., 275° C., 300° C., 325° C., 350° C., 375° C., 400° C., 425° C., 450° C., 475° C., 500° C., 525° C., 550° C., 575° C., 600° C., 625° C., 650° C., 675° C., 700° C., 725° C., 750° C., 775° C. and 800° C. In a further embodiment, the temperature is selected to be in a range from about 300° C. to 600° C. In one embodiment, the annealing step may be carried out under conditions of atmospheric pressure, in an environment containing gaseous oxygen suitable for the formation of the oxide phase of the particle as disclosed in the first aspect. In another embodiment, the composition of oxygen present in the environment may be selected from about 20%, 30%, 40%, 50%, 60%, 70%, 80%, 90%, or 100%.

In one embodiment, the thermal treatment step may be carried out between 1 hour to 16 hours, at a temperature selected from those provided earlier. In a preferred embodiment, the thermal treatment step may be carried out between 2 hours and 10 hours, at a temperature selected from those provided earlier.

In one embodiment, the choice of metal in forming the metal oxide particle, or the final composite material is selected from the group of: Al, Be, Mg, Ca, Sr, Ba, Ra, Sc, Ti, V, Cr, Mn, Fe, Co, Ni, Cu, Zn, Y, Zr, Nb, Mo, Ru, Rh, Pd, Ag, Cd, W, Pt, Au and Hg.

In one embodiment, the metallic element within the composite metal oxide or metal hydroxide is Mg.

In yet another embodiment, wherein prior to said irradiating process, a step of providing said metal hydroxide by a co-precipitation step is carried out. In one embodiment, the co-precipitation step comprises reacting a metal salt solution with a base to form said metal hydroxide. In one embodiment, the metal salt is selected from the group comprising of acetate, carbonate, chloride, fluoride, iodide, nitrate, nitrite, phosphate, sulphate, and sulphide. In yet another embodiment, the base is selected from the group comprising aluminum hydroxide, sodium hydroxide, potassium hydroxide, calcium hydroxide, ammonium hydroxide, lithium hydroxide, rubidium hydroxide and cesium hydroxide.

In a further embodiment, the metal hydroxide is optionally dried and ground prior to thermal treatment in step (b). In one embodiment, the temperature for drying the metal hydroxide is selected from about 50° C., 60° C., 70° C., 80° C. or 90° C. or in the range of temperatures from 50° C. to 100° C. In yet another embodiment, the metal hydroxide after drying is ground to an average particle size between the range of 1 μm to 1000 μm. In a preferred embodiment, the composite particle is ground to an average particle size between the range of 2 μm to 100 μm.

In another embodiment, the hydration step of (c) comprises hydrating the pure phase metal oxide in a solution mixture of acetone and water to form a composite particle. In a further embodiment, the ratio, by volume, of acetone to water is selected to be between the range of 0:100 to 50:50.

In another embodiment, the composite particle is a micro- or nano-sized particle. In a further embodiment, the size of the composite particle is selected from the range of 0.01 μm (10 nm) to 300 μm.

Exemplary, non-limiting embodiments of the methods according to the third aspect will now be disclosed.

In an embodiment, the composite particle comprises a metal oxide core encapsulated by a metal hydroxide outer shell.

In another embodiment, the size of the said composite particle is in the range of 0.01 μm to 1000 μm. In yet another embodiment, the size of the said composite particle is selected from one of the ranges of 1 μm-1000 μm, 10 μm-1000 μm, 100 μm-1000 μm, 0.01 μm-100 μm, 0.01 μm-10 μm, 0.01 μm-1 μm and 0.01 μm-0.1 μm.

In an embodiment, the composite particle is substantially halogen free.

In one embodiment, the composite particle is used as a fire-retardant additive. In another embodiment, the composite particle may be provided in a matrix selected from aerosols or emulsions. In a further embodiment, the matrix state may be in a compressed state. In yet a further embodiment, the composite particle may be paper, textile or polymer-based.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram representing the overall process of developing the core-shell composites.

FIG. 2(a) shows an X-Ray Diffraction (XRD) pattern of Mg(OH)₂ that was prepared from a co-precipitation step in the absence of irradiation.

FIG. 2(b) shows an XRD pattern of MgO formed after calcination of the precursor hydroxide.

FIG. 2(c) shows an XRD pattern of a MgO/Mg(OH)₂ core-shell composite.

FIG. 3(a) shows an X-Ray Diffraction (XRD) pattern of Mg(OH)₂ that was prepared from a co-precipitation step under microwave irradiation.

FIG. 3(b) shows an XRD pattern of MgO formed after annealing of the precursor hydroxide in FIG. 3(a).

FIG. 3(c) shows an XRD pattern of a MgO/Mg(OH)₂ core-shell composite formed in accordance with the present invention.

FIG. 4(a) is a Scanning Electron Microscope (SEM) image showing the surface morphology of Mg(OH)₂.

FIG. 4(b) shows an energy-dispersive X-Ray spectroscopy (EDX) analysis of the Mg(OH)₂ of FIG. 4(a).

FIG. 5 is a photographic image comparing the results of a flame test between filter paper loaded with the core-shell composites according to the present invention (right) and unloaded filter paper (left).

### DETAILED DESCRIPTION OF DRAWINGS

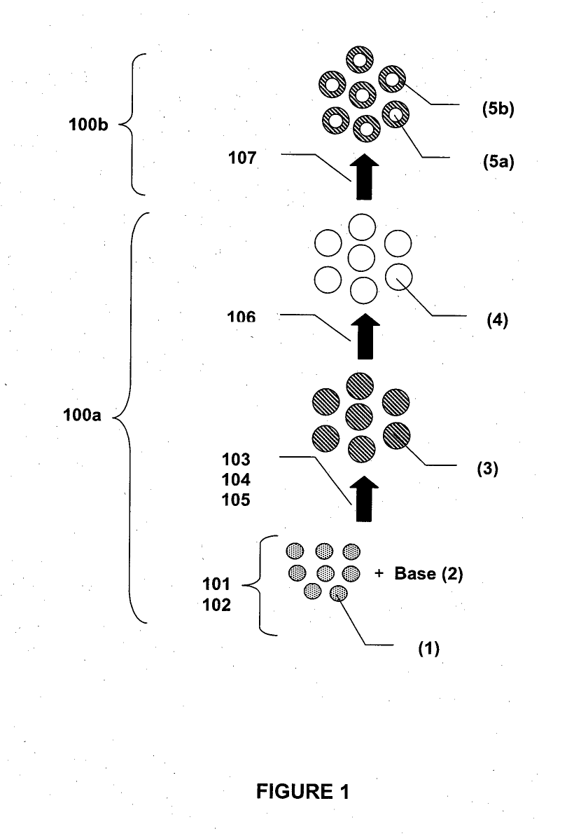

FIG. 1 is a schematic depicting the overall process of developing a core-shell composite. This process can be separated into two stages 100a and 100b. The earlier stage 100a refers to the synthesis of the core material while the latter 100b represents the synthesis of the core-shell structure. Typically, precursors to the process include a suitable metal salt 1 and a basic reagent 2. The metal salt 1 and basic reagent 2 participate in a co-precipitation 101 and/or microwave process 102 in a liquid state, forming ion-exchanged entities. One of these entities is a metal hydroxide 3. Through the process containing the steps of washing with a suitably-selected medium (e.g. water) 103, filtration 104 and centrifugation 105, metal hydroxide 3 is obtained. The dehydrated form of the metal hydroxide 3, i.e. a metal oxide 4, is obtained in heating 106 the metal hydroxide 3 in the presence of excess oxygen. A composite containing a hydrated form of the metal oxide 5b is formed upon contact with a hydrating agent available in the hydration process 107. The extent of hydration of the metal oxide 4 can be selectively controlled such that a composite containing unhydrated internal cores 5a and hydrated external shells 5b are formed.

### EXAMPLES

### Example 1

### Preparation of MgO (Core Material) without a Microwave-Assisted Method

Laboratory-grade magnesium chloride (99.99%) and sodium hydroxide (99.99%) were used as the precursors in the preparation of MgO powder. The starting solution was prepared by dissolving 40 g of magnesium chloride in 172 ml water. A white suspension was produced, indicating the formation of Mg(OH)₂ when sodium hydroxide (14.5 g in 172 ml of water) was slowly added to the solution under stirring in 30 minutes.

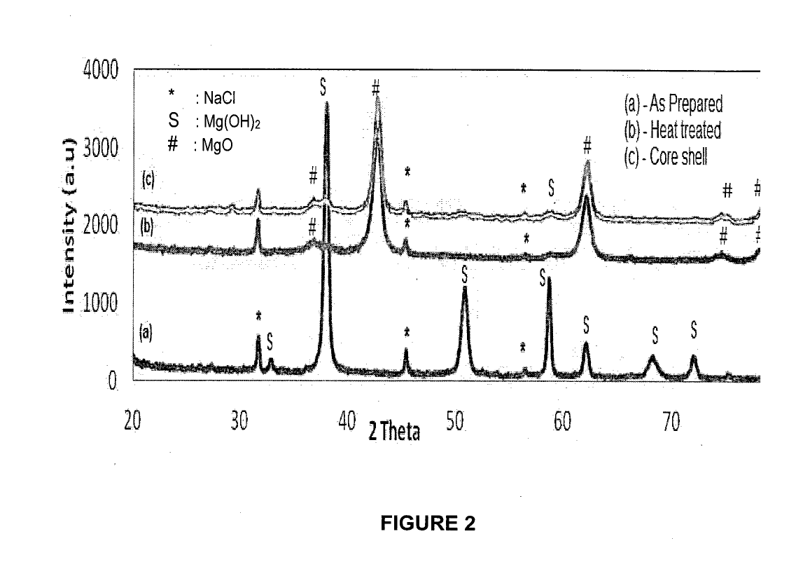

The Mg(OH)₂ is subsequently allowed to cool to room temperature after the exothermic hydration process. The resulting Mg(OH)₂ mixture was washed with copious amounts of distilled water, filtered and air-dried. The X-ray diffraction pattern of the resulting Mg(OH)₂ is shown in FIG. 2(a), wherein peaks at about 32.8, 38.0, 50.8, 58.1, 62.0, 68.2, 71.9 (° 2θ) confirm the presence of Mg(OH)₂.

The residual substance was then dried in an oven at 80° C. for 2-10 hours, and calcined in atmospheric air at 500° C. for 2-4 hours to produce the oxide phase of magnesium. The diffraction pattern of the calcined material (MgO) is shown in FIG. 2(b), wherein peaks at about 36.9, 42.8, 62.1, 74.1 and 78.1 (° 2θ) confirm the presence of MgO. The specific BET surface area of the calcined MgO material was found to be in the range of 10 m²/g to 100 m²/g.

Next, the MgO material is hydrated under a mixture of acetone and water to form a core shell structure, having an MgO core with an Mg(OH)₂ shell.

The XRD diffraction peaks at about 32.8, 36.6, 38.0, 42.8, 50.8, 58.1, 62.0, 62.1, 68.2, 71.9 and 74.1 (° 2θ) of the MgO—Mg(OH)₂ core-shell structure are shown in FIG. 2(c). The BET surface area of this composite material was found to be in the range of 10 m²/g to 100 m²/g.

### Example 2

### Preparation of MgO (Core Material) Using a Microwave-Assisted Method

Laboratory-grade magnesium chloride (99.99%) and sodium hydroxide (99.99%) were used as the precursors in the preparation of MgO powder. The starting solution was prepared by dissolving 40 g magnesium chloride in 172 ml water. A white suspension was produced, indicating the formation of Mg(OH)₂ when sodium hydroxide (14.5 g in 172 ml of water) was slowly added to the solution under stirring in 30 minutes. After further stirring for 2 hours, the mixture was exposed to microwaves for 0.1 h to 5 h and the power of the microwaves is selected from the range of 100 W to 1200 W.

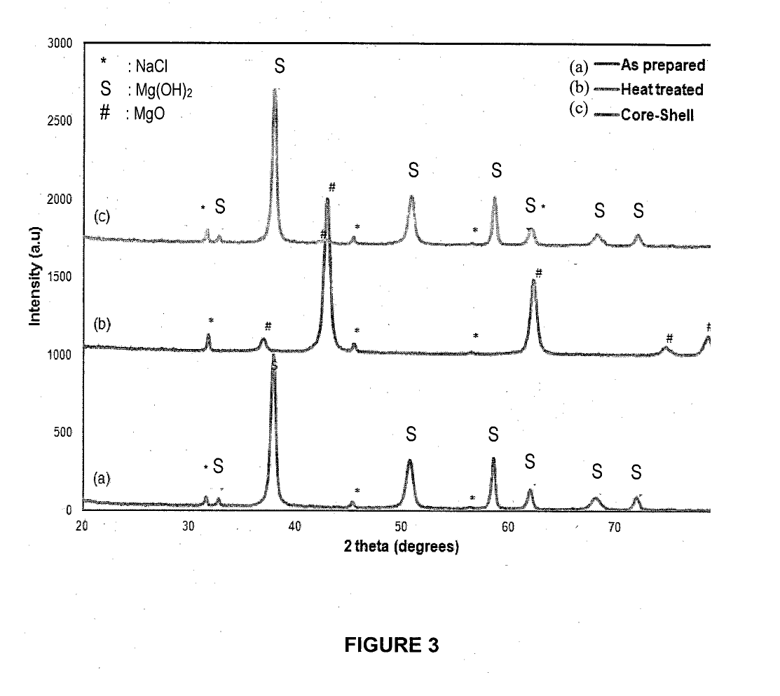

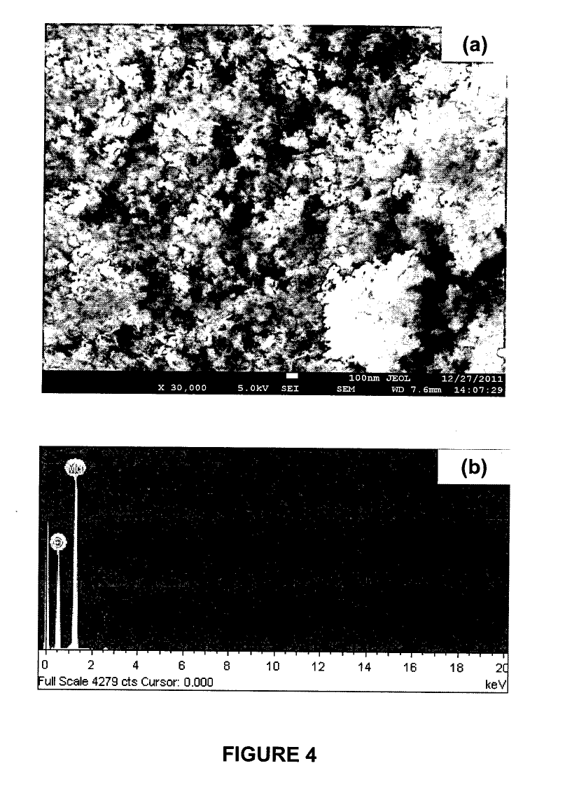

The Mg(OH)₂ is subsequently allowed to cool to room temperature. The resulting Mg(OH)₂ mixture was washed with copious amounts of distilled water, filtered and air-dried. The X-ray diffraction pattern of the Mg(OH)₂ material is shown in FIG. 3 (a), wherein peaks at about 32.8, 38.0, 50.8, 58.1, 62.0, 68.2 and 71.9 (° 2θ) confirm the presence of Mg(OH)₂. FIG. 4(a) shows an SEM image (×30 k) of the as-formed Mg(OH)₂ and the corresponding elements present in a local analysis based on the EDX technique (FIG. 4(b)). The particles of Mg(OH)₂ as viewed under the SEM appear to be aggregates of smaller particles less than 100 nm in size. The EDX analysis identifies the presence of oxygen, magnesium and silicon. The presence of silicon is attributed to the material of the sample holder used. The BET surface area for the as-prepared powders is in the range of 30 m²/g to 250 m²/g.

The Mg(OH)₂ was dried in an oven at 80° C. for 2-10 hours, and then calcined in atmospheric air at 500° C. for 2-4 hours to produce the oxide phase of magnesium. The diffraction pattern of the calcined material (MgO) is shown in FIG. 3(b), wherein peaks at about 36.9, 42.8, 62.1, 74.0 and 78.1 (° 2θ) confirm the presence of MgO.

The resulting material was further characterized using Scanning Electron Microscopy/Energy Dispersive X-Ray spectroscopy (SEM/EDX, JEOL 2010). The calcined material was found to possess a surface area in the range of 30 m²/g to 250 m²/g.

Next, the MgO material is hydrated under a mixture of acetone and water to form a core shell structure, having an MgO core with an Mg(OH)₂ shell.

The XRD diffraction peaks at 32.8, 36.6, 38.0, 42.8, 50.1, 50.8, 58.1, 62.0, 62.1, 68.2, 72.0 and 74.1 (° 2θ) of the MgO—Mg(OH)₂ core-shell structure are shown in FIG. 3(c). This composite material is found to possess a BET surface area in the range of 30 m²/g to 250 m²/g.

### Example 3

### Flame-Retardancy and Flexural Strength Tests

Three samples S1, S2 and S3 were prepared by loading a polymer with the core-shell composite structures according to the present invention at loadings of 5%, 25% and 50% respectively. The samples are tested according to the UL-94 standard for fire-retardancy, a plastics flammability standard released by Underwriters Laboratories (USA).

The standard classifies plastics according to how they burn in various orientations and thicknesses. From lowest (least flame-retardant) to highest (most flame-retardant), the classifications are:
HB: slow burning on a horizontal specimen; burning rate <76 mm/min for thickness <3 mm.
V2: burning stops within 30 seconds on a vertical specimen; drips of flaming particles are allowed.
V1: burning stops within 30 seconds on a vertical specimen; drips of particles allowed as long as they are not inflammed.
V0: burning stops within 10 seconds on a vertical specimen; drips of particles allowed as long as they are not inflamed.
5VB: burning stops within 60 seconds on a vertical specimen; no drips allowed; plaque specimens may develop a hole.
5VA: burning stops within 60 seconds on a vertical specimen; no drips allowed; plaque specimens may not develop a hole.

Tests are generally conducted on a 5″×½″ (12.7 cm×1.27 cm) specimen of the minimum approved thickness. For 5VA and 5VB ratings, tests are performed on both bar and plaque specimens, and the flame ignition source is approximately five times as severe as that used for testing the other materials.

The ASTM 790 standard covers the determination of flexural strength of all plastics, including high-modulus composites and electrical insulating materials in the form of rectangular bars moulded directly or cut from sheets, plates, or moulded shapes. The standard is generally applicable to both rigid and semi rigid materials. However, flexural modulus cannot be determined for those materials that do not break or that do not fail in the outer surface of the test specimen within the 5.0% strain limit of these test methods. The test utilizes a three-point loading system applied to a simply supported beam.

The results of the UL-94 and ASTM 790 tests are provided in Table 1 below.

TABLE 1

| | | | Results with various | | | |
|---|---|---|---|---|---|---|
| | | | loading % of core-shell | | | |
| | | | composites | | | Comparison |
| | | | S1 | S2 | S3 | with other |
| No. | Property | Standard | (5%) | (25%) | (50%) | materials |
| 1. | Flammability | UL-94 | V2 | V0 | V0 | Commercial |
| | | | | | | loading of |
| | | | | | | 60% |
| 2. | Flexural Modulus | ASTM 790 | 136.72 | 140.74 | 373.18 | N/A |
| | (MPa) | | | | | |

The test specimens were prepared through the following processes. Firstly, a mixture of low density polyethylene ethylene (LDPE) and the MgO/Mg(OH)₂ composite material was extruded at an optimum temperature and time. The blend was fed through a spinneret and solidified rapidly, forming a thin wire. The blended wire was shaped into small pellets thus forming the base material for injection molding. The required sizes of the test specimens for use in the UL-94 and the ASTM 790 tests were molded via injection molding.

From Table 1, it can be seen that even at a low composite loading of both 25% on vertical test specimens (as compared to typical loadings of 60% typically used in commercial products), a V-0 standard could be achieved.

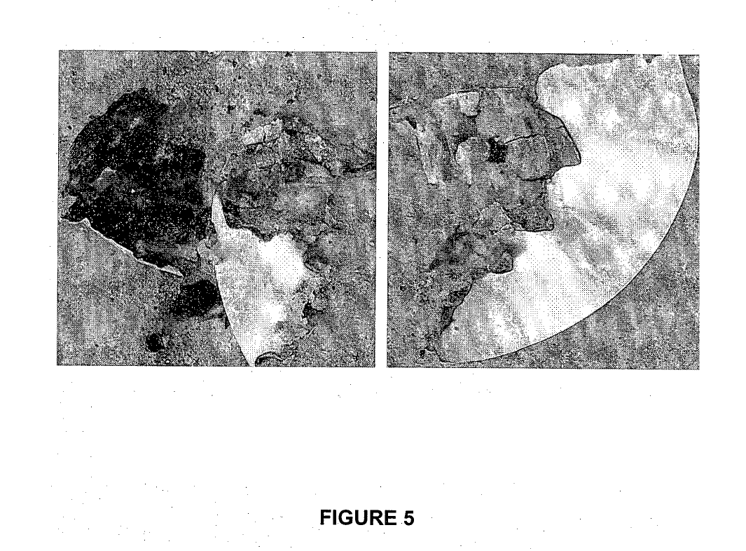

FIG. 5 is a photograph showing the result of an in-house test on the fire-retarding capability of the MgO—Mg(OH)₂ composite. Filter paper (both coated/uncoated with the composite) was exposed to a flame. The uncoated filter paper had burnt for a duration of 10 seconds, while the MgO—Mg(OH)₂-coated filter paper maintained burning for 32 seconds. The burnt-through area in the case of the uncoated filter paper was relatively larger than that of the coated one.

### APPLICATIONS

Metal hydroxides and metal oxides are effective compounds suitable for use in fire or flame-retarding applications.

Metal hydroxides are found as fillers for reducing the flammability of composite materials. They are low-cost, and are widely used, in instances, with high weight-loadings (e.g. up to 450% in some materials) in order to achieve adequate flame retardancy. At elevated temperatures, the formation of water during the decomposition of metal hydroxides restricts the access of oxygen to the surfaces they are applied to, and also serve in diluting the concentration of any evolving flammable gases in combustion.

On the other hand, metal oxides are also used as fire-resistant materials. These ceramic materials possess relatively high melting points and are able to withstand thermal stresses well. When applied, they build a protective layer on the surface, and cut off sources of heat at the point of the combustion. In addition, metal oxides have also been found to enhance limiting oxygen indices (LOI) when combined with an intumescent flame retardant (IFR)-thermoplastic polyurethane (TPU) composites composite. Such composites are widely used in industrial equipment parts including wires, cables, conveyor belts and protective coverings.

The synergistic advantages offered by a fire-retarding composite system of metal oxide-metal hydroxide particles as disclosed herein not only consist of the individual benefits presented by separate metal oxides and metal hydroxides when used as fire-retardants, but also offer better fire-control characteristics and mixing properties. For example, the composite particles may be introduced in relatively smaller amounts as additives into building materials (e.g. concrete), naval or aerospace structures, paints, or textiles. Furthermore, since the disclosed composite system of metal oxide-hydroxide particles does not contain any halogen compounds, they have the potential to be used in aerial fire-mitigation strategies, especially in the control of forest fires.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1-8. (canceled)

9. A method of producing a composite particle having a metal oxide inner core encapsulated by a metal hydroxide outer shell comprising the steps of:
(a) irradiating a metal hydroxide particle under conditions to increase the porosity of said metal hydroxide particle to yield a porous metal hydroxide;
(b) thermally treating said porous metal hydroxide particle under conditions to yield a pure phase crystalline metal oxide;
(c) hydrating said pure phase crystalline metal oxide under conditions to form a metal oxide inner core and a metal hydroxide outer shell.

10. The method of claim 9, wherein said step of irradiating comprises use of microwaves of frequencies of 300 MHz to 300 GHz.

11. The method of claim 9, wherein said thermal treatment step (b) comprises thermal annealing.

12. The method of claim 11, wherein said annealing step comprises subjecting said metal hydroxide particle to a temperature selected from 200° C. to 800° C.

13. The method of claim 12, wherein said annealing step is performed under atmospheric pressure.

14. The method of claim 13, wherein the annealing step is undertaken for a duration selected from 1 hour to 16 hours.

15. The method of claim 9, wherein said metal hydroxide particle is formed of a metal selected from the group consisting of: Al, Be, Mg, Ca, Sr, Ba, Ra, Sc, Ti, V, Cr, Mn, Fe, Co, Ni, Cu, Zn, Y, Zr, Nb, Mo, Ru, Rh, Pd, Ag, Cd, W, Pt, Au and Hg.

16. The method of claim 15, wherein said metal is Mg.

17. The method of claim 9, wherein prior to irradiation step (a), further comprising a step of preparing said metal hydroxide particle via a co-precipitation step.

18. The method of claim 17, wherein said co-precipitation step comprises contacting a metal salt solution with a base to yield said metal hydroxide particle.

19. The method of claim 18, wherein said metal hydroxide particle is dried and ground prior to said thermal treatment step (b).

20. The method of claim 9, wherein said hydration step (c) comprises hydrating said pure phase crystalline metal oxide in a solution comprising a mixture of acetone and water.

21. The method of claim 9, wherein said composite particle is a micro- or nano-sized particle.

22-23. (canceled)

24. The method of claim 9, wherein both of said metal oxide inner core and metal hydroxide outer shell are crystalline.

25. A composite particle comprising a metal oxide inner core encapsulated by a metal hydroxide outer shell.

26. The composite particle according to claim 25, wherein said metal of the metal oxide inner core and the metal hydroxide outer shell is selected from the group consisting of Al, Be, Mg, Ca, Sr, Ba, Ra, Sc, Ti, V, Cr, Mn, Fe, Co, Ni, Cu, Zn, Y, Zr, Nb, Mo, Ru, Rh, Pd, Ag, Cd, W, Pt, Au and Hg.

27. The composite particle according to claim 25, wherein both of said metal oxide inner core and said metal hydroxide outer shell are crystalline.

28. The composite particle according to claim 25, wherein the size of the said composite particle is in the range of 0.01 μm to 1000 μm.

29. The composite particle according to claim 25, wherein said composite particle is substantially halogen free.

30. Use of the composite particle according to claim 25 as a fire-retardant.
